(19) United States
(12) Patent Application Publication
(10) Pub. No.: US 2024/0281576 A1
(43) Pub. Date: Aug. 22, 2024

(54) DETERMINING LIKELIHOODS OF COMPUTER SYSTEM STATE TRANSITIONS BASED ON STATE TRANSITION HISTORIES

(71) Applicant: HEWLETT PACKARD ENTERPRISE DEVELOPMENT LP, Spring, TX (US)

(72) Inventor: Debdipta Ghosh, Bangalore (IN)

(21) Appl. No.: 18/169,972

(22) Filed: Feb. 16, 2023

(51) Int. Cl. G06F 30/27

(52) U.S. Cl. CPC G06F 30/27; G06F 2111/08

(57) ABSTRACT

A process includes accessing data representing a directed graph model state for a computer system. The directed graph includes a plurality of transitions among the model states, and the directed graph includes, for each transition, a transition identifier that is associated with the transition and a probability that is associated with the transition. The process includes characterizing a history of the computer system to reach a current state of the computer system. The current state corresponds to a given model state and the history corresponds to first transitions. Characterizing the history includes, based on the data, identifying first transition identifiers associated with the first transition, and applying a first arithmetic operator to the first transition identifier to provide a history identifier, which corresponds to the history. The process includes, based on the history identifier, determining a likelihood that the computer system will transition from the current state to a given future state; and based on the likelihood, initiating a responsive action in anticipation of the computer system transitioning to the given future state.

### BACKGROUND

A computer system may experience one or multiple hardware or software failures, or faults. Although a computer system may be able to recover from some faults without failing, other faults may lead to a system failure.

### BRIEF DESCRIPTION OF THE DRAWINGS

FIG. 1 is a block diagram of a rack-based computing system having a traversable Markov chain analysis and update engine according to an example implementation.

FIG. 2 is an illustration of a traversable Markov chain according to an example implementation.

FIG. 3 is a flow diagram depicting a process that uses a traversable Markov chain to determine whether a computer system is likely to transition to a particular future state according to an example implementation.

FIG. 4 is a flow diagram of a process to respond to a system state change detection according to an example implementation.

FIG. 5 is an illustration of a traversable Markov chain according to a further example implementation.

FIG. 6 is a flow diagram depicting a process to, based on a state transition history of a computer system, determine a likelihood that the computer system will transition to a given future state and initiate a responsive action based on the likelihood according to an example implementation.

FIG. 7 is an illustration of machine-readable instructions stored on a non-transitory storage medium, which, when executed by a machine, cause the machine to determine a likelihood that a computer system will transition to a given future state and initiate a responsive action based on the likelihood according to an example implementation.

FIG. 8 is a block diagram of a system that includes computer systems and a management controller to determine a likelihood that a computer system will transition to a given future state and initiate a responsive action based on the likelihood according to an example implementation.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

A relatively complex computer system may have hardware and software components from a number of different hardware manufacturers and software vendors. Due to potential defects with one or multiple of these components as well as component degradation, the computer system may experience various faults, over its lifetime. The computer system may have a built-in capacity to address some faults without causing the computer system to fail (e.g., shut down or be reset). For example, over time, one or multiple memory modules of a computer system may degrade and experience memory bit errors. The computer system may have a built-in self-healing capacity to address some memory bit errors. As examples of its self-healing capacity, the computer system may apply error correction code (ECC); swap out defective memory banks or ranks with spare banks/ranks; perform hard post package repair (hPPR); and perform soft post package repair (sPPR). The computer system's self-healing capacity, however, may be exhausted over time (e.g., there may be no remaining spare banks or ranks), which may lead to a failure of the computer system.

In the context used herein, a computer system “failing” refers to the computer system transitioning to a terminal, failed state. As an example, a failed state may refer to the computer system powering down. As another example, a failed state may refer to the computer system entering a reset. As another example, a failed state may refer to the computer system freezing, or becoming unresponsive.

It may be advantageous to accurately predict when a computer system of a larger computer network is likely to fail so that one or multiple remedial actions may be undertaken in advance of the failure to prevent or at least minimize disruption to the remainder of the computer network. As an example of a remedial action, virtual machines that are hosted by a computer system that is predicted to fail may be migrated to one or multiple other computer systems before the failure occurs. As another example of a remedial action, the responsibility of a workload that is managed by a computer system that is predicted to fail may be transferred to one or multiple other computer system before the failure occurs. As another example of a remedial action, operations between a computer system that is predicted to fail and another computer system of the network may be quiesced before the failure occurs. As another example of a remedial action, an alert may be communicated to a system administrator, a failover system or other system and/or personnel. Accurately predicting computer system failure imparts a higher stability to a computer system and enhances the Reliability, Availability and Service (RAS) features of the computer system.

A computer network may have an analysis engine that uses a directed graph to predict whether a given computer system of the network is likely to fail. Here, a “directed graph” refers to a set of vertices, which are interconnected by edges (also referred to as “transitions” herein). The vertices of the directed graph correspond to respective events or states (also called “model states” herein) for the computer system. As a more specific example, the directed graph may represent a Markov chain. More specifically, the Markov chain may have vertices that correspond to model states for the computer system and edges (corresponding to transitions among the model states) to which probabilities are assigned.

In general, a Markov chain allows a prediction of the likelihood that a computer system will transition to a future model state, given that the computer system is in a current model state. For a Markov chain in which a current model state is connected by a single edge (or “transition”) to a future model state, the likelihood of the computer system transitioning from the current model state to the future model state is the probability that is assigned to the edge. The likelihood of a computer system transitioning from the current model state to the future model state along a particular multiple vertice path is the product of the probabilities that are assigned to the edges of the path.

In accordance with example implementations that are described herein, a Markov chain of model states for a computer system is supplemented with state transition identifiers to create a traversable Markov chain. In this context, a “traversable Markov chain” refers to a Markov chain that has features that allows a state transition history of a given model state of the chain to be traced. In this context, a “state transition history” of a given model state refers to the particular path taken in the Markov chain to reach the given model state. In accordance with example implementations, a state transition identifier identifies a specific corresponding edge, or transition, of the Markov chain. The particular state transition identifiers of the edges, or transitions, traversed in a particular path to reach a particular model state may be mathematically combined to form a state transition history identifier for the path. As described herein, the likelihood that a computer system will transition from a current model state to a future model state may be predicted based on a state transition history that is provided by the traversable Markov chain.

In general, a Markov chain assigns probabilities to different edges, or transitions, of the chain, and without the state transition history tracing available with a traversable Markov chain, predicting the likelihood of a future state from a model state along a particular path merely considers the probabilities that are assigned to the transitions of this path. For example, a computer system may be currently in a state that corresponds to model state A of a non-traversable Markov chain.

Assuming that model state A is connected to model state B by a corresponding edge having a probability λ_{AtoB}, then, according to the non-traversable Markov chain, the likelihood that the computer system will transition from model state A to model state B is λ_{AtoB}. Assuming that model state B is connected to model state C by a corresponding edge having a probability λ_{BtoC}, then, according to the non-traversable Markov chain, the likelihood that the computer system will transition from model state A to model state C is λ_{AtoB}−λ_{BtoC}.

There may be multiple potential paths to reach a current model state. For example, model state C (the current model state for this example) may be reached from model state A or model state B. There may be respective edges, or transitions, from model state C to model states D, E and F, and each of these transitions may be assigned respective likelihoods, or probabilities, λ_{CtoD} (e.g., λ_{CtoD}=0.1), λ_{CtoE} (e.g., λ_{CtoE}=0.2) and λ_{CtoF} (e.g., λ_{CtoF}=0.7) of the transition occurring. A predicted future state likelihood based solely on these probabilities is independent of the particular path taken to reach model state C. Therefore, according to the foregoing example, the likelihood of reaching a particular model state from model state C does not depend on whether model state C is reached from model state A or model state B. Stated differently, according to a non-traversable Markov chain, the likelihood of whether a computer system will transition from a current model state to a future model state does not depend on the history of state transitions taken to reach the current model state.

The traversable Markov chain's ability to account for a state transition history may improve predictions of whether or not a computer system transitions to particular future states. For example, when a memory module of a computer system first experiences a multiple bit error, the computer system may apply one or multiple remedial measures (e.g., bank sparing, rank sparing, sPPR and/or hPPR) to isolate the corresponding defective memory cells and continue with normal operations without transitioning to a terminal, failed state. The occurrence of a multiple bit error or the application of any one of the remedial measures by itself may not increase the likelihood that the computer system will fail. However, a particular pattern or sequence of events (e.g., bank sparing or rank sparing has been used several times), i.e., the computer system's state transition history, may reflect whether the computer system's self-healing capacity for addressing memory bit errors has been exhausted and therefore, may be beneficial in predicting the computer system's future state.

As further described herein, in accordance with example implementations, the state transition identifier may be a prime number, such that each transition, or edge, of the traversable Markov chain is assigned a different prime number. As also described further herein, a particular path of the traversable Markov chain may be represented by a mathematical combination of the state transition identifiers for the path. This mathematical combination provides a state transition history identifier. For example, for implementations in which the state transition identifiers are prime numbers, a particular path of the traversable Markov chain may be specifically identified by the product of the prime numbers (the state transition identifiers) that are assigned to the transitions, or edges, of the path. Accordingly, a state transition history for a given model state, which corresponds to a particular path taken to reach the given model state, may be specifically identified by the product of the prime numbers (the state transition identifiers) that are assigned to the path. The product is a state transition history identifier for the path. Due to the properties of prime numbers, a product representing a particular state transition history may be decomposed into prime number factors, and these prime number factors correspond to the transitions, or edges, of the state transition history. Here, a “prime number” refers to a number other than “1” whose factors are limited to the number and “1.” A “factor” of a number divides the number without leaving a remainder.

In accordance with example implementations, an analysis engine may classify states of a computer system as corresponding to model states of a traversable Markov chain. The model states may be learned from any of a number of different techniques, such as machine learning; knowledge bases; expert inputs; and observations and updates that are made by the analysis engine; a combination of different techniques; and other techniques. For a given current model state (corresponding to a current state of the computer system), the analysis engine may determine a corresponding state transition history identifier, which represents a path leading to the given current model state. For example, there may be multiple potential paths to reach a current model state G, including the following example paths: Path 1, Path 2 and Path 3. Path 1 includes the following state transition sequence: Model State D>Model State E>Model State G (where “>” denotes an edge or transition). Path 2 includes the following state transition sequence: Model State B>Model State G. Path 3 includes the following state transition sequence: Model State H>Model State M>Model State B>Model State G. Path 1, Path 2 and Path 3 for this example have state transition history identifiers IDSH1, IDSH2 and IDSH3, respectively, that are different from one another.

For purpose of assessing the likelihood that the computer system will transition to a future state that corresponds to a future model state of the traversable Markov chain, the analysis engine may access a state transition table. The state transition table contains records that correspond to respective model states, and each record contains data identifying one or multiple probable path(s) to reach the corresponding model state. For example, in accordance with example implementations, each record of the state transition table contains data that represents one or multiple probable path identifiers that correspond to respective probable paths leading to the model state. In accordance with example implementations in which prime numbers are used as state transition identifiers for the traversable Markov chain, the record contains one or multiple numbers, where each number may be decomposed into prime number factors, and the prime number factors represent the transitions, or edges, of the corresponding probable path.

In accordance with example implementations, the analysis engine may determine a likelihood of a computer system transitioning from a current model state to a particular future model state (e.g., a terminal, failed state) by accessing the record of the state transition table that corresponds to the particular future model state. The analysis engine may then identify where any of the probable path(s) should be considered as candidate probable paths. In this context, a “candidate probable path” refers to a path that is consistent with the state transition history of the current model state.

In accordance with example implementations, a probable path is a candidate probable path if the state transition history of the current model state is a subset of the probable path. In accordance with example implementations in which prime numbers are used as state transition identifiers for the traversable Markov chain, a number represents the probable path and a number represents the state transition history of the current model state. As an example, the number representing the state transition history of the current model state may be the product of prime numbers corresponding to transitions (e.g., all transitions or a predetermined number of the most recent transitions) to reach the current model state, and the number representing the probable path may be correspond to the product of prime numbers corresponding to the transitions to reach the future model state. The analysis engine may determine whether the number representing the state transition history is a factor of the number representing the probable path. If so, then, in accordance with example implementations, the state transition history of the current model state is a subset of the probable path leading to the future model state, and the analysis engine may designate the probable path as being a candidate probable path.

In accordance with some implementations, if the analysis engine identifies a single candidate probable path from the state transition table record, then the analysis engine uses the Markov chain probability(ies) of the candidate probable path to determine a likelihood of the computer system transitioning to the future model state from the current model state. The analysis engine may then compare the likelihood to a predefined action threshold. In accordance with example implementations, this comparison is used to determine whether or not the computer system is likely to transition to the future model state. If so, then the analysis engine may initiate one or multiple responsive actions.

If the analysis engine identifies multiple candidate probable paths from the record of the state transition table, then, in accordance with example implementations, the analysis engine uses the Markov chain probability(ies) to determine, for each candidate probable path, a likelihood of the computer system transitioning from the current model state to the future model state along the candidate probable path. The analysis engine may then select the candidate probable path that has the greatest likelihood and compare this likelihood to the predefined action threshold for purposes of determining whether or not to initiate one or multiple responsive actions.

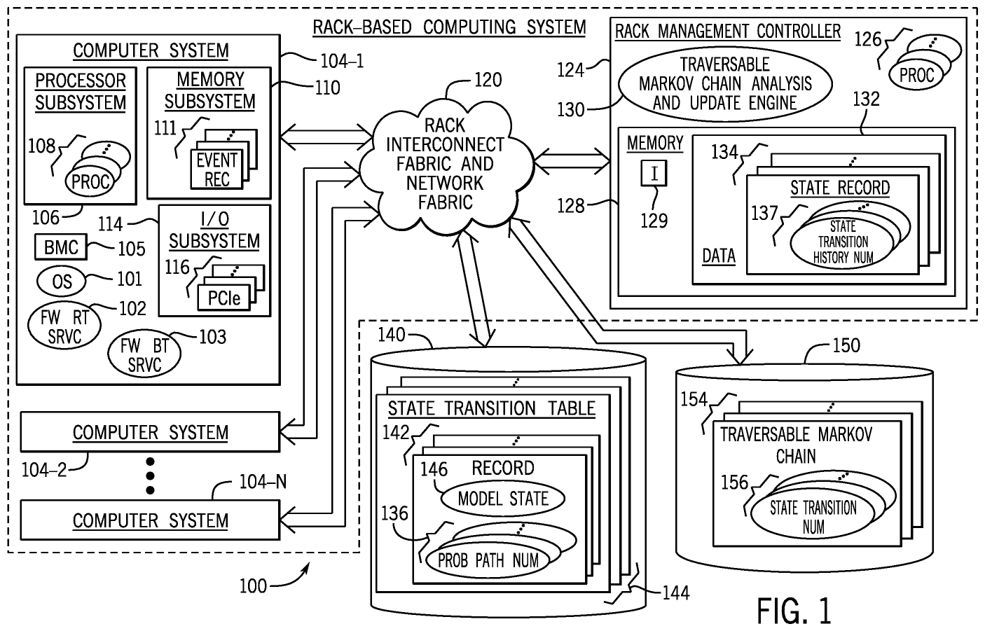

Referring to FIG. 1, as a more specific example, in accordance with some implementations, a traversable Markov chain analysis and update engine (called the “engine 130” herein) uses traversable Markov chains 154 to predict the transitions of computer systems 104 (N computer system 104-1, 104-2 . . . 104-N, being represented in FIG. 1) to future states and selectively initiate remedial actions based on the predictions.

For the example implementation that is depicted in FIG. 1, the engine 130 is part of a rack management controller 124 (e.g., a chassis management controller) of a rack-based computing system 100. In the context used herein, a “computer system” may be a logical or physical entity. For example, in accordance with some implementations, the rack-based computing system 100 may include a rack that includes one or multiple rack-based computer platforms, such as rack-based servers, blade servers, network switches, gateways or storage arrays. As more specific example, the rack-based computing system 100 may contain blade servers, and a given blade server may contain one or multiple nodes, wherein each node corresponds to an independent operating system instance. For this example, a node may be considered a computer system 104, and as such a given blade server may contain multiple computer systems. As another example, in accordance with further implementations, a computer system 104 may be a logical instance of a computer platform, such as a logical instance of a blade server or a rack-based server. For example, in accordance with some implementations, a computer system 104 may be a virtual machine instance or a container instance that is hosted by a computer platform (e.g., a blade server or a rack-based server). As another example, in accordance with further implementations, a computer system 104 may be a physical entity that corresponds to a computer platform (e.g., a blade server or rack-based server) in its entirety. As other examples, in accordance with further implementations, a computer system 104 may be a logical or physical entity that corresponds in whole or in part to one or multiple computer platforms, whether rack-based or not.

Regardless of its particular form or architecture, a computer system 104 may have or be associated with one or multiple subsystems. As specifically illustrated for the computer system 104-1, as examples, the subsystems may include a processor subsystem 106 (e.g., a subsystem containing one or multiple processors 108, such as central processing units (CPUs) 108 and/or graphics processing units (GPUs)); a memory subsystem 110 (e.g., a subsystem containing memory modules); and an I/O subsystem 114 (e.g., a subsystem containing one or multiple Peripheral Component Interconnect express (PCIe) cards 116).

In general, the electrical components that form the memory subsystem 110, as well as other memories and storage media that are described herein, may be formed from non-transitory memory devices, such as semiconductor storage devices, flash memory devices, memristors, phase change memory devices, a combination of one or more of the foregoing storage technologies, or other electrical components. Moreover, the memory devices may be volatile memory devices (e.g., dynamic random access memory (DRAM) devices, static random access (SRAM) devices, and so forth) or non-volatile memory devices (e.g., flash memory devices, read only memory (ROM) devices and so forth), unless otherwise stated herein.

In accordance with example implementations, a given computer system 104 may log event records 111 (e.g., system logs, uncorrectable error logs, memory errors, memory error correction events, hardware fault logs, error fault logs, as well as other logs), which may, for example, correspond to a sequence of events for one or multiple of the computer system's subsystems. In accordance with some implementations, the event records 111 may be generated by any of a number of different entities associated with the computer system 104, such as processors 108, an operating system 101, firmware runtime services 102, firmware boot services 103, applications, drivers, as well as other hardware and/or software components. Moreover, data may be stored in the memory subsystem 110 representing the event records 111.

In accordance with some implementations, events for a particular subsystem of the computer system 104 correspond to respective states of the computer system 104 corresponding to the subsystem, with the most recent event corresponding to what is referred to herein as a current state of the computer system 104. For example, the memory subsystem 110 may have a no memory error state (called a “NOERR state”) when there are currently no memory bit errors for the subsystem 110, and the current state of the computer system 104 (corresponding to the memory subsystem 110) may be a NOERR state.

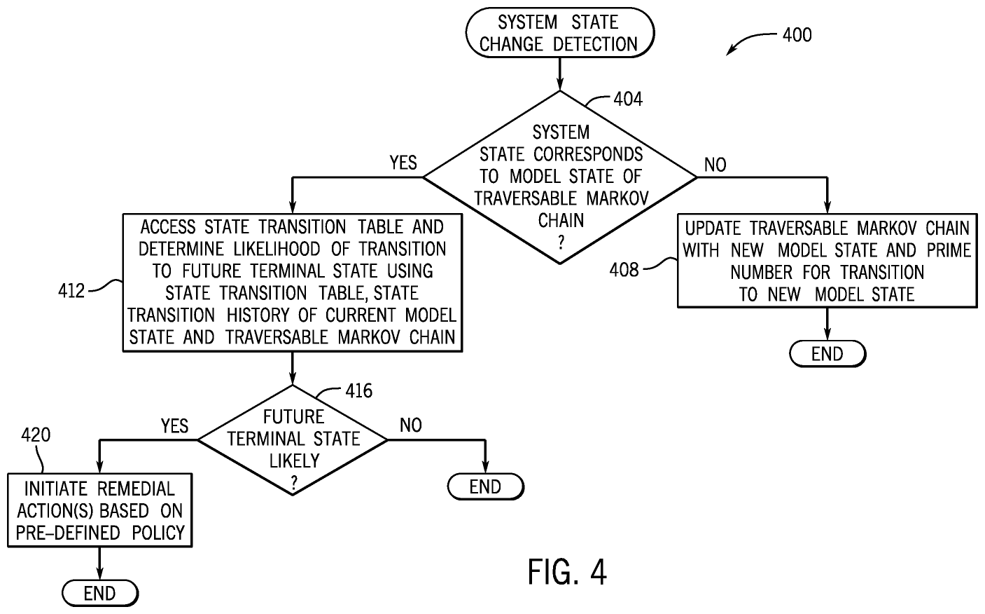

The engine 130, in accordance with example implementations, uses a traversable Markov chain 154 to track the states of a particular subsystem of the computer system 104. In this manner, in accordance with example implementations, a traversable Markov chain 154 contains model states that correspond to potential states of a particular subsystem of the computer system 104. In this manner, a particular subsystem may have a current state that corresponds to a current model state of the traversable Markov chain 154. In accordance with example implementations, the engine 130 determines, based on event records 111 of the computer system 104, the current state of the subsystem and maps the current state to a corresponding model state of the traversable Markov chain 154. If the current state of the subsystem is a new state that does not correspond to a model state of the traversable Markov chain 154, then the engine 130 updates the chain 154 with a corresponding new model state, as further described herein in connection with FIG. 4.

In general, in accordance with example implementations, the engine 130 may track the states of a particular subsystem using an associated traversable Markov chain 154. As depicted in FIG. 1, in accordance with some implementations, a centrally accessible database 150 may store data that represents one or multiple traversable Markov chains 154. As an example, in accordance with some implementations, a particular traversable Markov chain 154 may be associated with a particular type of subsystem, such as, for example, the processor subsystem 106, the memory subsystem 110 or the I/O subsystem 114. For specific implementations that are described herein, a particular traversable Markov chain 154 contains model states for the memory subsystem 110. In accordance with further example implementations, a given traversable Markov chain 154 may contain model states for a combination of subsystems of the computer system 104. Moreover, depending on the particular implementation, a particular traversable Markov chain 154 may be used for a specific computer system 104, or a particular traversable Markov chain 154 may be used for multiple computer systems 104.

In accordance with some implementations, the engine 130 accesses the traversable Markov chains 154 via rack interconnect fabric and network fabric 120. As examples, the rack interconnect fabric may include a backplane of the rack-based computing system, network cables, one or multiple network switches and one or multiple bus interfaces. The network fabric may be associated with one or multiple types of communication networks, such as (as examples) Fibre Channel networks, Compute Express Link (CXL) fabric, dedicated management networks, local area networks (LANs), wide area networks (WANs), global networks (e.g., the Internet), wireless networks, or any combination thereof.

In accordance with example implementations, the traversable Markov chain 154 includes state transition identifiers. In accordance with example implementations, the state transition identifiers are prime numbers and are referred to as “state transition numbers 156” herein. In accordance with example implementations, the state transition numbers 156 are different from one another, which allows a specific state transition of the traversable Markov chain 154 to be identified by a corresponding state transition number 156. In the context used herein, a prime number refers to a whole number in which the sole factors of the whole number are the whole number and one. In accordance with example implementations, by definition, “one” is not considered a prime number.

The use of prime numbers to identify state transitions provides the ability to construct snapshots of state transition histories. More specifically, in accordance with example implementations, a state transition history of a particular model state of the traversable Markov chain 154 may be represented by the product of the prime numbers of the state transitions of the path leading to the model state. For example, the state transition history of a particular model state of the traversable Markov chain 154 may be as follows: Model State H>Model State M>Model State B>Model State G. For this example, the transition from Model State H to Model State M may be assigned a prime number P₁, the transition from Model State M to Model State B may be assigned a prime number P₂, and the transition from Model State B to Model State G may be assigned a prime number P₃.

The corresponding state transition history may be represented by a state transition history identifier, called a “state transition history number” herein. For the foregoing state transition history example, the corresponding state transition history number is P₁P₂P₃. Given the properties of prime numbers, the factors of P₁P₂P₃ are P₁, P₂, and P₃ (excluding one as being a prime number). As such, in accordance with example implementations, the engine 130 may determine whether a particular transition is part of a particular state transition history by determining whether the corresponding state transition number 156 is a factor of the state transition history number. Additionally, in accordance with example implementations, the engine 130 may determine whether a particular state transition history is a subset of a particular transition path by determining whether the corresponding state transition number 156 is factor of the product of prime numbers representing the transition path.

In accordance with example implementations, the engine 130 may maintain data 132 in a memory 128, which represents state records 134 that contain state transition history numbers 137. As an example, a given state record 134 may correspond to a particular computer system 104. More specifically, in accordance with some implementations, a given state transition history number 137 of a given state record 134 may corresponds to a particular subsystem of a computer system 104 and identify a state transition history of the subsystem. Moreover, in accordance with some implementations, a given state record 134 may include multiple state transition history numbers 137 that correspond to different subsystems of a computer system 104 and respectively represent the state transition histories of the subsystems. In accordance with example implementations, a state transition history number 137 represents a snapshot of the path leading to the current state of a subsystem.

In response to a subsystem transitioning from one state to another state, the engine 130 updates the state transition history number 137 to reflect the changed state transition history. For example, in accordance with example implementations, the engine 130 multiplies the current state transition history number 137 with the prime number for the transition to the next model state to derive an updated state transition history number 137. In accordance with some implementations, the engine 130 may limit the state transition history number 137 to reflect the most recent (the last 5 or another number) transitions of the state transition history. As another example, in accordance with further implementations, the engine 130 may not place a limit on the number of transitions that are represented by the state transition history number 137.

The engine 130 may access, in accordance with example implementations, a state transition table 144 for purposes of predicting whether a computer system 104 is likely to transition to a particular future model state. More specifically, in accordance with some implementations, state transition tables 144 may be stored in a central database 140, which is accessible via the rack interconnect and network fabric 120. Moreover, a particular state transition table 144 may, in accordance with example implementations, be associated with a particular type of subsystem. Depending on the particular implementation, different state transition tables 144 may correspond to different subsystem categories, may correspond to a combination of different subsystem categories, may correspond to specific subsystems of specific computer systems 104, and so forth. For the particular example implementation that is described herein, a state transition table 144 corresponds to a memory subsystem and may be used for one or multiple computer systems 104.

In accordance with example implementations, the state transition table 144 includes records 142, where each record 142 corresponds to a particular model state 146 of a traversable Markov chain 154. Moreover, the record 142 contains data that identifies one or multiple probable paths leading to the model state 146. In this context, a “probable path” refers to a path that has been identified through learning or observations (e.g., machine learning, learning via databases or expert input, or learning by the engine 130) as being a likely path to the model state 146. In accordance with some implementations, the record 142 includes data representing one or multiple probable path numbers 136, where each probable path number 136 represents a snapshot of a particular probable path. In accordance with some implementations, the probable path number 136 is the product of prime numbers that correspond to the transitions, or edges, of the probable path.

In accordance with example implementations, the engine 130 may determine whether the state transition history of the current model state is consistent with a particular probable path to the model state 146. Determining whether or not a state transition history is consistent with a probable path may be performed in any of a number of different ways. Regardless of the methodology used, the determination may be based on a probable path number 136 that corresponds to the probable path and a state transition history number 137 that corresponds to the state transition history. In an example, the engine 130 may determine whether the state transition history number 137 (corresponding to the current model state) is a factor of the probable path number 136, and if so, then the engine 130 considers the state transition history to be consistent with the probable path.

In another example, the engine 130 may decompose the probable path number 136 and the state transition history number 137 into their prime number factors and determine whether the state transition history is consistent with the probable path based on the state transition history and the probable path having the same corresponding prime number factors. In another example, determination of whether the state transition history is consistent with a probable path may involve considering the structure of the traversable Markov chain 154 in conjunction with the prime number factors of the state transition history number 137 and the probable path number 136.

If the engine 130 determines that a probable path is consistent with the state transition history then, in accordance with example implementations, the engine 130 considers the path to be a candidate probable path to the future model state 146. There may be more than one candidate probable path for a given future model state 146. In accordance with example implementations, after the engine 130 identifies (if any) the candidate probable path(s) to the future model state 146, then, in accordance with example implementations, the engine 130 may use the probabilities, or the likelihoods, that are set forth in the traversable Markov chain 154 to identify most likely candidate probable path to the future model state 146. For example, the most likely candidate probable path may be that path that has the highest probability, or highest likelihood, as calculated from the state transition probabilities that are set forth by the traversable Markov chain 154.

The engine 130 may then, in accordance with example compare the likelihood of the most likely candidate probable path to a threshold, for purposes of determining whether to initiate one or multiple remedial actions. In accordance with some implementations, the engine 130 may compare the likelihood of the most likely candidate path to multiple thresholds, with the comparison result for each threshold comparison being used to determine whether or not to initiate a corresponding set of one or multiple responsive actions. For example, in accordance with some implementations, a first lower threshold may be used for purposes of determining whether or not the engine 130 is to send a message alerting a system administrator that there is an increased likelihood of the computer system 104 transitioning to a particular future state. A second threshold higher than the first threshold may be used by the engine 130 to, for example, determining whether to initiate the migration of relatively higher priority virtual machines from the computer system 104. A third threshold higher than the second threshold may be used by the engine 130 to, for example, determine whether to initiate the migration of relatively lower priority virtual machines from the computer system 104. A fourth threshold higher than the third threshold may be used by the engine 130 to, for example, determine whether to initiate actions to quiesce operations between the computer system 104 and one or multiple other computer systems. In accordance with further implementations, the engine 130 may use more or fewer than four thresholds, and moreover, the thresholds may be associated with remedial actions different from the foregoing example actions.

In accordance with some implementations, the engine 130 may be part of a rack management controller 124 of the rack-based computing system 100. As a more specific example, in accordance with some implementations, the rack management controller 124 may be a chassis management controller. In accordance with example implementations, the chassis management controller allows remote monitoring and management of components of the rack-based computing system 100.

As used herein, a “chassis management controller” is a specialized service processor that, in general, manages and reports on the operation of a computer environment (such as the rack-based computing system 100), which may have multiple servers, storage devices, and networking devices. The chassis management controller may operate independently of the operating system(s) of the computer systems 104. The chassis management controller may be located on the motherboard or main circuit board of a server or other device to be monitored. The fact that a chassis management controller is mounted on a motherboard of the managed server/hardware or otherwise connected or attached to the managed server/hardware does not prevent the chassis management controller from being considered “separate” from the server/hardware. As used herein, a chassis management controller has management capabilities for sub-systems of a computing device, and is separate from a processing resource that executes an operating system of a computing device. The chassis management controller is separate from a processor, such as a central processing unit, which executes a high level operating system or hypervisor on a system.

In accordance with further implementations, the engine 130 may be part of a processor-based platform other than a rack management controller 124. As an example, the engine 130 may be an administrative computer system of a cluster that contains the computer systems 104. As another example, the engine 130 may be part of a particular computer system 104. As another example, the engine 130 may be distributed among multiple computer platforms. As another example, the engine 130 may be distributed among multiple computer systems 104. As another example, the engine 130 may be located on a remote server (e.g., part of a server located at a different geographical site, such as, for example, a site other than a data center that houses the computer systems 104). Depending on the particular implementation, one or both databases 140 and 150 may be at the same location of the engine 130 or may be remote from the engine 130. In accordance with some implementations, one or both databases 140 and 150 may correspond to data stored in the memory 128 of the rack management controller 124. In accordance with some implementations, one or both databases 140 and 150 may correspond to data stored in the memory of one or multiple computer systems 104.

In accordance with example implementations, the engine 130 may be formed from one or multiple hardware processing cores 126 of the rack management controller 124 executing machine-readable instructions (e.g., machine-readable instructions 129 that are stored in a memory of the rack management controller 124, such as the memory 128). In accordance with further implementations, functions of all or part of the engine 130 may be performed by dedicated hardware (e.g., logic gates) without executing machine-readable instructions. The dedicated hardware may, depending on the particular implementation, be or include an application specific integrated circuit (ASIC), a field programmable gate array (FPGA), a complex programmable logic device (CPLD), or other hardware.

In accordance with some implementations, the computer system 104 may contain a baseboard management controller 105, which communicates with the rack management controller 124 for purposes of performing a wide variety of management-related functions, including communicating copies of the event records 111 to the rack management controller 124. In this way, the engine 130 may traverse the records 111 for purposes of detecting state transition changes of the computer system 104, tracking the states of the computer system 104 via one or multiple traversable Markov chains 154, updating the state records 134, as well as performing other functions that are set forth herein.

As used herein, a “baseboard management controller” is a specialized service processor that monitors the physical state of a server or other hardware using sensors and communicates with a management system through a management network. The baseboard management controller 170 may communicate with applications executing at the operating system level through an input/output controller (IOCTL) interface driver, a representational state transfer (REST) application program interface (API), or some other system software proxy that facilitates communication between the baseboard management controller and applications. The baseboard management controller may have hardware level access to hardware devices located in a server chassis including system memory.

The baseboard management controller may be able to directly modify the hardware devices. The baseboard management controller may operate independently of the operating system of the server or other device to be monitored. The baseboard management controller may be located on the motherboard or main circuit board of the server or other device to be monitored. The fact that a baseboard management controller is mounted on a motherboard of the managed server/hardware or otherwise connected or attached to the managed server/hardware does not prevent the baseboard management controller from being considered “separate” from the server/hardware.

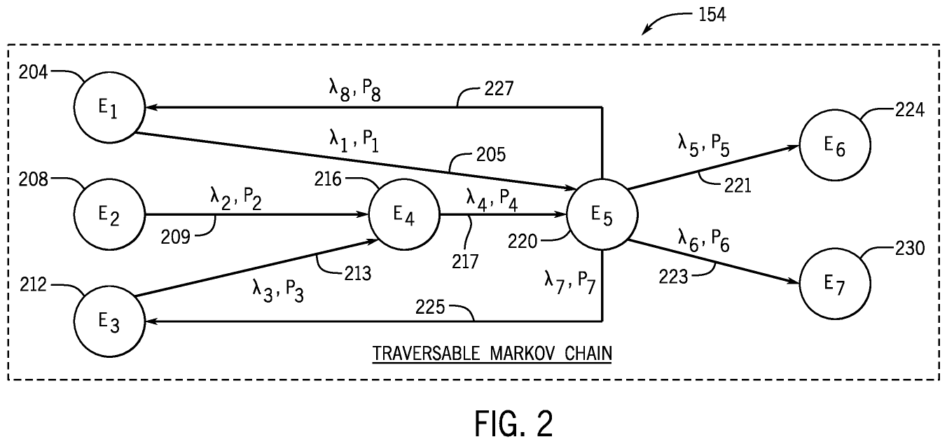

FIG. 2 depicts an example traversable Markov chain 154 in accordance with example implementations. Referring to FIG. 2, the traversable Markov chain 154 includes model states 204, 208, 212, 216, 220, 224 and 230, which correspond to events E1, E2, E3, E4, E5, E6 and E7, respectively. As an example, a particular event may be an error model state and/or a model state in which the computer system applies a self-healing measure to correct an error. As another example, a particular model state may correspond to a failed, terminal state at which the computer system powers down or is reset. For the example implementation that is depicted in FIG. 2, the model states 224 and 230 may be failed terminal states.

For the following discussion, it is assumed that the computer system has a current state that corresponds to model state 220. As can be seen from FIG. 2, the following transitions are possible from the model state 220: a transition 227 to model state 204, a transition 225 to model state 212, a transition 221 to model state 224, or a transition 223 to model state 230.

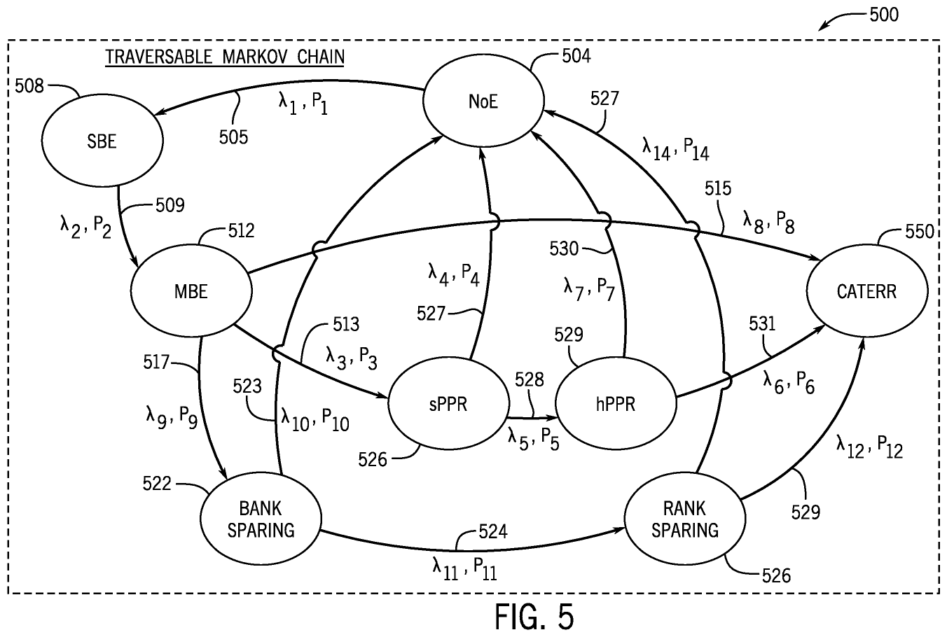

Each of these transitions has a corresponding likelihood, or probability, that is represented by the traversable Markov chain 154. As depicted in FIG. 2, the traversable Markov chain 154 represents a λ₅ probability of a transition 221 from the state 220 to the state 224 and further represents a λ₆ probability of a transition 223 from the state 220 to the state 230. Although these probabilities may represent the overall proportionate transitions to the states 224 and 230, for a given state history, one or both of the transitions 221 and 223 may or may not occur. For example, as further described below in connection with a more detailed example traversable Markov chain of FIG. 5, the model state 220 may be, for example, a state in which the computer system first applies a remedial measure to correct a multiple memory bit error in a particular memory module for the first time. Moreover, for this example, the model state 224 may be a terminal state that occurs when all self-healing measures have been exhausted to correct memory bit errors for the memory module. Given this example state history for the model state 220, the transition 221 is not a probable transition (e.g., the transition 221 has an actual probability of zero, given the state history). The computer system may exhaust self-healing measures to correct multiple bit memory errors with the same memory module and eventually again end up in a state that corresponds to model state 220. When this occurs, given the state history of model state 220, the transition 221 is now likely, or probable, and has a corresponding λ₅ probability.

The traversable Markov chain 154 has built-in state transition numbers, which allow the state transition history for a given model state to be traced. This, in turn, allows the state transition history of a particular model state to be considered for purposes of identifying the one or multiple probable paths from the current model state.

As a more specific example, in accordance with some implementations, there are many possible state transition histories for the model state 220, which may correspondently influence which future paths are probable from the model state 220. For example, one possible state transition history for the model state 220 includes a transition 209 from the model state 208 to the model state 216 and then a transition 217 from the model state 216 to the model state 220. In accordance with example implementations, the traversable Markov chain 154 includes prime numbers (i.e., state transition identifiers), which are assigned to the different edges, or transitions, of the traversable Markov chain 154. Continuing the example, as depicted in FIG. 2, a prime number P₂ is assigned to the transition 209, and a prime number P₄ is assigned to the transition 217. In accordance with example implementations, a state transition history corresponds to a product of the prime numbers of the transitions of the history. Continuing the example, here, the state transition history including the transitions 209 and 217 may be represented by the product of the P₂ and P₄ prime numbers, or P₂P₄.

The P₂P₄ product is a snapshot of a state transition history for the model state 220. Due to the mathematical properties of prime numbers, the prime number factors of the P₂P₄ product are the P₂ prime number and the P₄ prime number. As such, the P₂P₄ snapshot reveals the specific transitions 209 and 217 of the state transition history.

The model state 220 may have other state transition histories. For example, another state transition history may be a transition 225 from the model state 220 to the model state 212, then a transition 213 from the model state 212 to the model state 216, and then, a transition 217 from the model state 216 to the model state 220. This example state transition history has an associated snapshot of P₇P₃P₄. As another example, a state transition history for the model state 220 may be a transition 227 from the model state 220 to the model state 204, and then a transition 205 from the model state 204 to the model state 220. This state transition history has an associated snapshot of P₈P₁.

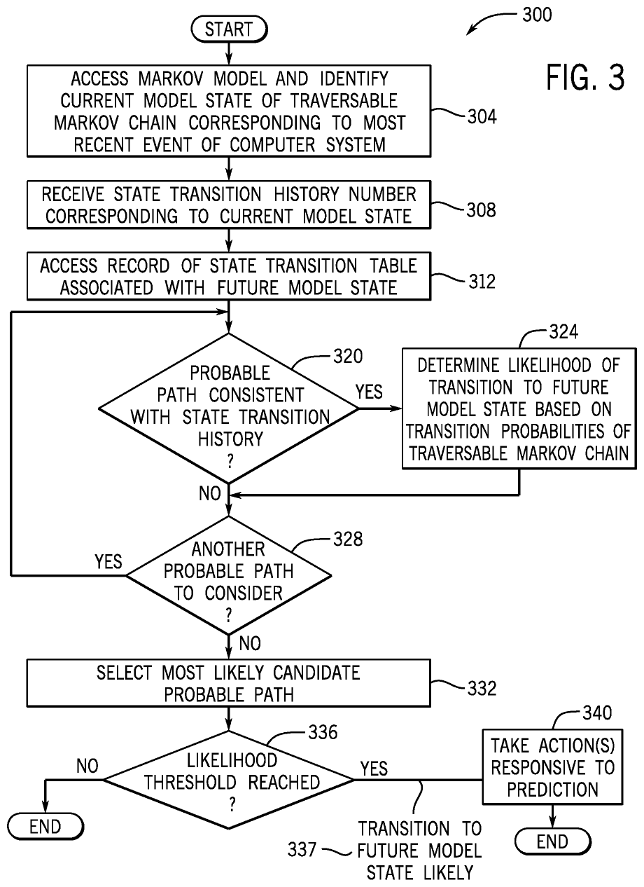

Referring to FIG. 3, in accordance with example implementations, a process 300 may be performed for purposes of determining whether a subsystem is likely to transition to a future state that corresponds to a particular future model state of a traversable Markov chain. More specifically, in accordance with some implementations, the process 300 may be performed by the engine 130 of FIG. 1.

Referring to FIG. 3, in accordance with example implementations, the process 300 includes accessing (block 304) the current model state of the Markov chain corresponding to the most recent event of the computer system and retrieving (block 308) a state transition history number associated with the current model state. Pursuant to block 312, a record of a state transition table associated with the future model state is then accessed, and next, a subprocess begins to determine whether any of the probable paths of the record are candidate paths to consider. More specifically, the subprocess includes, for the next probable path, determining (decision block 320) whether the probable path is consistent with the state transition history. If so, then, pursuant to block 324, the process 300 incudes determining a likelihood of transition to the future model state based on the transition probabilities of the traversable Markov model. Control then proceeds (whether from the NO prong of decision block 320 or from block 324) to decision block 328 in which a decision is made whether there is another probable path to consider. If so, control returns to block 320 to perform another iteration of the subprocess to identify candidate probable paths.

Otherwise, the subprocess to identify any candidate probable paths concludes, and pursuant to block 332, the process 300 includes selecting the most likely candidate probable path. In accordance with example implementations, the process 300 then proceeds to determine whether the mostly likely candidate probably path (of the candidate probable paths) is deemed to be a likely path from the current model state. This evaluation may be performed in a number of different ways. For the example implementation that is depicted in FIG. 3, the process 300 determines the likelihood, or probability, of the most likely candidate probable path from the probabilities that are set forth in the traversable Markov chain and compares likelihood to a likelihood threshold. The process 300 then determines, pursuant to decision block 336, whether a the likelihood reaches (e.g., is the same or greater) than the likelihood threshold. If so, then, as indicated at 337, the future model state is deemed likely, and pursuant to block 340 of the process 300, one or multiple actions may then be taken responsive to the prediction that transition of the computer system to the future state is likely.

FIG. 4 depicts a process 400 for responding to a system state change detection. For example, a system state may be a state change in a particular subsystem. As examples, a state change may be caused by a particular error (e.g., a memory bit error or a multiple memory bit error) or may be the result of the application of a particular self-healing measure by the computer system. In general a state change corresponds to a transition of the computer system from one state to another state. In accordance with some implementations, the process 400 may be performed by the engine 130 of FIG. 1.

Referring to FIG. 4, in accordance with example implementations, the process 400 includes determining (decision block 404) whether the system state corresponds to a model state of the traversable Markov chain. If not, then, pursuant to block 408, the traversable Markov chain is updated with the new state and updated with the prime number for the transition to the new state.

Otherwise, if the system state corresponds to a model state of the Markov chain (pursuant to decision block 404), then, pursuant to block 412, the state transition table is accessed and a determination a likelihood of a transition to a future terminal state is determined using the state transition table, the state transition history of the current model state and the traversable Markov chain, as described herein. Block 412 may involve, in accordance with example implementations, determining a probability of the transition. This probability may then be used as an input to determine whether, pursuant to block 416, the transition to the future state is to be deemed likely enough to cause the initiation of one or multiple remedial actions, pursuant to block 420. This determination may involve the application or one or multiple policies. For example, a policy may specify one or multiple remedial actions to be performed, depending on whether the probability exceeds threshold(s) corresponding to the remedial action(s). If, pursuant to decision block 416, transition to the future state is not deemed to be likely, then, the process 400 terminates.

FIG. 5 depicts an example traversable Markov chain 500 in accordance with a further example implementation. Referring to FIG. 5, the traversable Markov chain 500 includes model states for a memory subsystem. More specifically, the traversable Markov chain 500 includes a no error model state 504 (called an “NoE model state 504” herein), which is the state for no outstanding memory bit errors.

The memory subsystem may experience, at a given time, one or multiple memory bit errors.

In accordance with example implementations, responsive to the occurrence of a memory bit error, the memory subsystem may transition to a state corresponding to a single bit error (SBE) model state 508 of the traversable Markov chain 500. This transition is represented by transition 505, and the traversable Markov chain 500 assigns a λ₁ probability and a prime number P₁ to the transition 505. The SBE model state 508 corresponds to the memory subsystem applying error correction codes (ECC) for purposes of handling single bit errors. The traversable Markov chain 500 includes a transition 509 from the SBE model state 508 to a multiple bit error (MBE) model state 512, which corresponds to occurrence of multiple memory bit errors.

As depicted in FIG. 5, the transition 509 may be assigned a λ₂ probability and a P₂ prime number. In the MBE model state 512 corresponds to the computer system evaluating whether self-healing options are available and may result in the computer system selecting a self-healing option. As an example, the self-healing action may correspond to a transition 513 to a soft Post Package Repair (sPPR) model state 526. The transition 513 may be assigned a λ₃ probability and a P₃ prime number. In the sPPR model state 526 corresponds to the computer system determining whether sPPR, a temporary repair should be applied and further determining whether a permanent, hard PPR (hPPR) repair should be employed, which prompts a transition (as depicted at 528) to an hPPR model state 529. As depicted in FIG. 5, the transition 528 may be associated with a λ₅ probability and a P₅ prime number.

If sPPR is performed to resolve the multiple memory bit errors, then a transition 527 (having a λ4 probability and a P₄ prime number) occurs from the sPPR model state 526 to the NoE model state 504. Likewise, if hPPR resolves the multiple memory bit errors, then a transition 530 (having a λ₇ probability and a P₇ prime number) occurs from the hPPR model state 549 to the NoE model state 504.

It is possible that the self-healing measures to correct multiple memory bit errors are not possible. For example, the memory bit errors may be too extensive or other self-healing measures may have been exhausted. FIG. 5 depicts a transition 531 (having a λ₆ probability and a P₆ prime number) from the hPPR model state 529 to a catastrophic error model state 550 (called a “CATERR model state 550” herein), which corresponds to a terminal, failed state for the computer system. The CATERR model state 550 may be reached by other paths, such as a transition 517 (having a λ₉ probability and a P₉ prime number) to a BANK SPARING model state 522 in which a spare bank is activated, and a transition 523 (having a λ₁₀ probability and a P₁₀ prime number) occurs back to the NoE model state 504. If bank sparing is not sufficient to resolve the multiple memory bit error, then a transition 524 (having a λ₁₁ probability and a P₁₁ prime number) may occur to a RANK SPARING model state 526. In the RANK SPARING model state 526, a spare rank is substituted for the rank having the memory bit errors, and if this resolves the memory bit errors, then a transition 527 (having a λ₁₄ probability and a P₁₄ prime number) occurs back to the NoE model state 504. However, as depicted by transition 529 (having a λ₁₂ probability and a P₁₂ prime number), the rank sparing may not resolve the memory bit error, and as such, the computer system may transition to a state corresponding to the CATERR model state 550.

From the MBE model state 512, there are three possible transitions 513, 515 and 517. The transition 515 (having a λ₈ probability and a P₈ prime number) is a path to the CATERR model state 550. Considering the state transition history leading to the MBE state 512, the transition 515 to the CATERR model state 550 may not be a probable path. For example, if there have been no previous post package repair, bank sparing or rank sparing, then the transition 515 may not be considered a probable path. However, a previous history of post package repair, bank sparing and/or rank sparing, may correspond to the transition 515 being a probable path to the CATERR model state 550. As such, for example, if the computer system is in a state that corresponds to the MBE model state 512, the likelihood of the computer system transitioning to the CATERR state may be more accurately predicted using the state transition history of the MBE model state 512, the traversable Markov chain and the state transition table, as described herein.

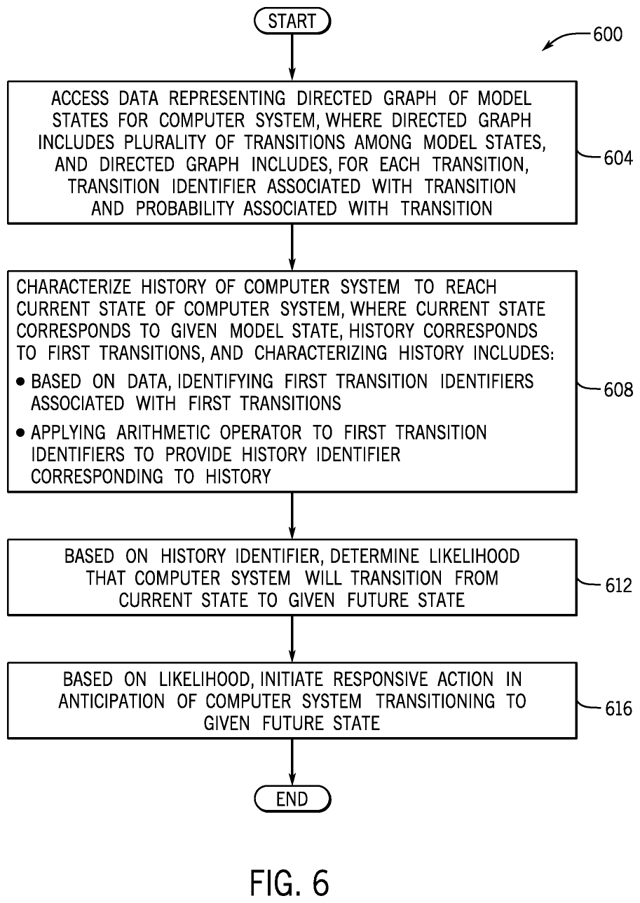

Referring to FIG. 6, in accordance with example implementations, a process 600 includes accessing (block 604) data that represents a directed graph of model states for a computer system. As an example, the directed graph may be a Markov chain. The directed graph includes a plurality of transitions among the model states, and the directed graph includes, for each transition, a transition identifier that is associated with the transition and a probability that is associated with the transition. As an example, the transition identifier may be a prime number, and each transition of the directed graph may be assigned a different prime number. The computer system may be a logical or physical computer system, such as virtual machine, a container, a computer platform (e.g., a blade server, a rack-based server, a network switch, a storage array or a gateway), part of a computer platform or multiple computer platforms.

The process 600 includes characterizing (block 608) a history of the computer system to reach a current state of the computer system. The history may be a path of transitions, or edges, of the directed graph, leading to the current state. The current state corresponds to a given model state and the history corresponds to first transitions.

In accordance with example implementations, the characterization (block 608) of the history includes, based on the data, identifying first transition identifiers associated with the first transitions, and applying a first arithmetic operator to the first transition identifiers to provide a history identifier, which corresponds to the history. As an example, the first transition identifiers may be prime numbers, and the applying the first arithmetic operator includes determining the product of the prime numbers.

Pursuant to block 612, the process 600 includes, based on the history identifier, determining a likelihood that the computer system will transition from the current state to a given future state. Determining the likelihood may include, as an example, accessing a state transition table record corresponding to the given future state and determining whether a probable path represented by data of the record is consistent with the history of the computer system. Determining the likelihood may include evaluating multiple candidate probable paths and using a traversable Markov chain to select the candidate probable path that has the greatest likelihood. The process 600 includes, pursuant to block 616, based on the likelihood, providing an alert to trigger a remedial action for the computer system. Providing the alert may include determining that the likelihood is equal to or surpasses a predefined threshold. Providing the alert may include applying a policy that sets forth one or multiple remedial actions. A remedial action may include migrating a virtual machine from the computer system to another computer system. A remedial action may include migrating a container from the computer system to another computer system. A remedial action may include transferring a workload from the computer system to another computer system. A remedial action may include quiescing operations of the computer system with one or multiple other computer systems. A remedial action may include sending an alert message to a system administrator.

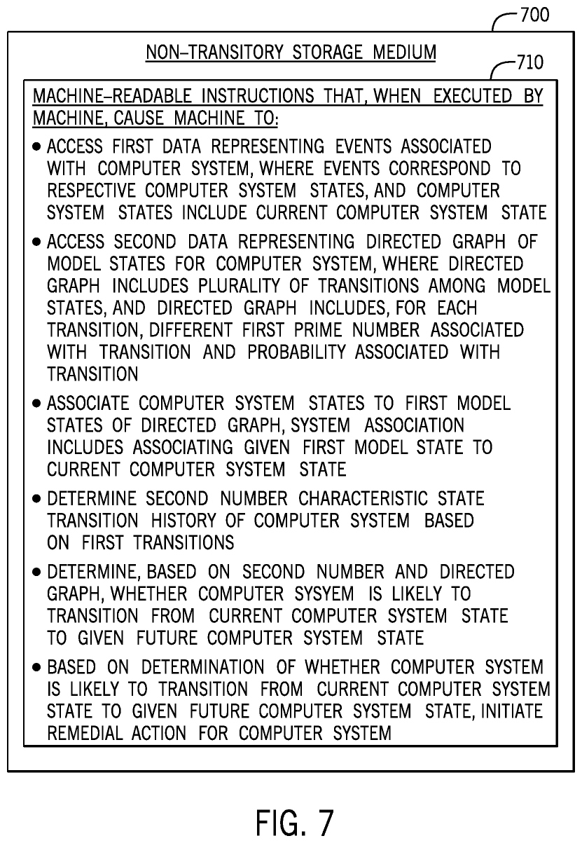

Referring to FIG. 7, in accordance with example implementations, a non-transitory storage medium 700 stores machine-readable instructions 710. The instructions 710, when executed by a machine, cause the machine to access first data that represents events that are associated with a computer system. The computer system may be a logical or physical computer system, such as virtual machine, a container, a computer platform (e.g., a blade server, a rack-based server, a network switch, a storage array or a gateway), part of a computer platform or multiple computer platforms.

The instructions 710 may be executed by one or multiple processing cores of a rack management controller or chassis management controller. The events correspond to respective computer systems states, and the computer system states includes a current computer system state. The instructions 710, when executed by the machine, further cause the machine to access second data that represents a directed graph of model states for the computer system. As an example, the directed graph may be a Markov chain. The directed graph includes a plurality of transitions among the model states, and the directed graph includes, for each transition, a different first prime number that is associated with the transition and a probability that is associated with the transition. As an example, the directed graph may be associated with a memory subsystem of the computer system and correspond to different states of the memory subsystem.

The instructions 710, when executed by the machine, further cause the machine to associate computer system states to first model states of the directed graph. The association includes associating a given first model state to a current computer system state. The instructions 710, when executed by the machine, further cause the machine to determine a second number characterizing a state transition history of the computer system based on the first transitions. The instructions 710, when executed by the machine, further cause the machine to determine, based on the second number and the directed graph, whether the computer system is likely to transition from the current computer system state to a given future computer system state.

The instructions 710, when executed by the machine, further cause the machine to, based on the determination of whether the computer system is likely to transition from the current computer system state to the given future computer system state, initiate a remedial action for the computer system. Determining the likelihood may include, as an example, accessing a state transition table record corresponding to the given future state and determining whether a probable path represented by data of the record is consistent with the history of the computer system. Determining the likelihood may include evaluating multiple candidate probable paths and using a traversable Markov chain to select the candidate probable path that has the greatest likelihood. A remedial action may include migrating a virtual machine from the computer system to another computer system. A remedial action may include migrating a container from the computer system to another computer system. A remedial action may include transferring a workload from the computer system to another computer system. A remedial action may include quiescing operations of the computer system with one or multiple other computer systems. A remedial action may include sending an alert message to a system administrator.

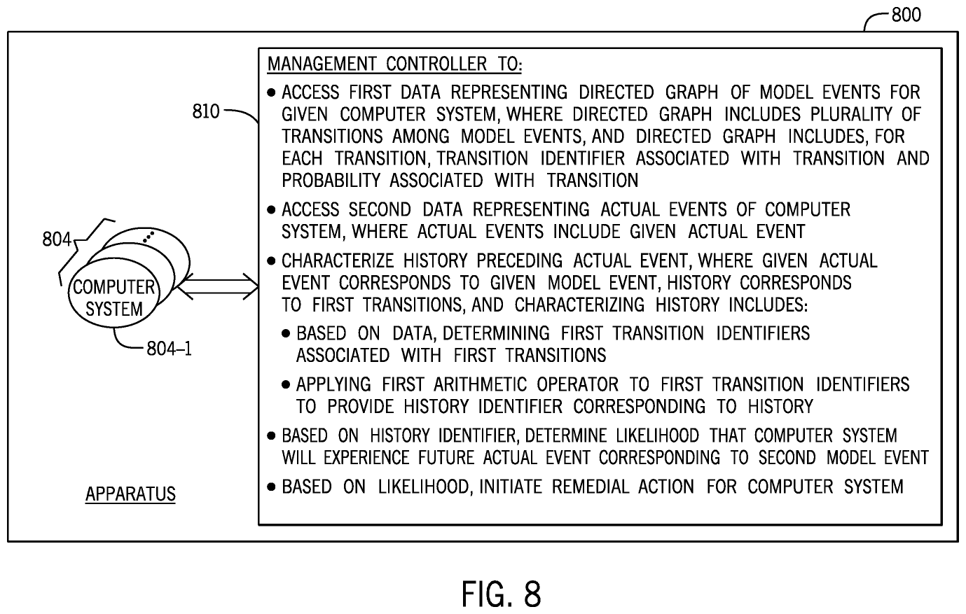

Referring to FIG. 8, in accordance with example implementations, an apparatus 800 includes a plurality of computer systems 804, which includes a first computer system 804-1. The apparatus 800 further includes a management controller 808. The management controller 808 to access first data representing a directed graph of model events for the first computer system. The directed graph includes a plurality of transitions among the model events, and the directed graph includes, for each transition, a transition identifier that is associated with the transition and a probability that is associated with the transition. The management controller may be a chassis management controller. The directed graph may be a Markov chain. The directed graph may be a traversable Markov chain that has built-in edge, or transition, identifiers to identify transitions of the Markov chain so that transition histories may be traced.

The computer system 804-1 may be a logical or physical computer system, such as virtual machine, a container, a computer platform (e.g., a blade server, a rack-based server, a network switch, a storage array or a gateway), part of a computer platform or multiple computer platforms.

The management controller to further access second data that represents actual events of the first computer system. The actual events include a given actual event. The management controller 808 to further characterize a history of the first computer system preceding the actual event. The given actual event corresponds to a given model state, and the history corresponds to first transitions. Characterizing the history includes, based on the data, determining first transition identifiers associated with the first transitions, and applying a first arithmetic operator to the first transition identifiers to provide a history identifier that corresponds to the history.

The first transition identifiers may be prime numbers, such that a different prime number may be assigned to each transition of the directed graph. The history identifier may be the product of transitions of the prime numbers correspond to transitions of the history.

The management controller to further, based on the history identifier, determine a likelihood that the first computer system will transition to a second state, and based on the likelihood, provide an alert to trigger a remedial action for the first computer system. Determining the likelihood may include, as an example, accessing a state transition table record corresponding to the given future state and determining whether a probable path represented by data of the record is consistent with the history of the computer system. Determining the likelihood may include evaluating multiple candidate probable paths and using a traversable Markov chain to select the candidate probable path that has the greatest likelihood. A remedial action may include migrating a virtual machine from the computer system to another computer system. A remedial action may include migrating a container from the computer system to another computer system. A remedial action may include transferring a workload from the computer system to another computer system. A remedial action may include quiescing operations of the computer system with one or multiple other computer systems. A remedial action may include sending an alert message to a system administrator.

In accordance with example implementations, the next state corresponds to a terminal state corresponding to a failure of the first computer system. The process further includes, responsive to the alert, failing over the computer system to another computer system. A particular advantage is that consideration of the state transition history provides a more accurate prediction of future states, such as failure states.

In accordance with example implementations, failing over the computer system includes at least one of migrating a virtual machine of the computer system to the other computer system, or transferring a workload that is assigned to the computer system to the other computer system. A particular advantage is that consideration of the state transition history provides a more accurate prediction of future states, such as failure states.

In accordance with example implementations, the first transition identifiers include prime numbers and the directed graph corresponds to a Markov chain. A particular advantage is that consideration of the state transition history provides a more accurate prediction of future states, such as failure states.

In accordance with example implementations, applying the first arithmetic operator includes determining a product of the prime numbers. A particular advantage is that consideration of the state transition history provides a more accurate prediction of future states, such as failure states.

In accordance with example implementations, determining the likelihood that the computer system will transition to the next state includes identifying a path of the directed graph based on the history identifier. The path includes the given model state, the first transitions and a second model state corresponding to the given future state. A particular advantage is that consideration of the state transition history provides a more accurate prediction of future states, such as failure states.

In accordance with example implementations, the history identifier includes a first number, and the path is associated with a second number. Identifying the path includes determining whether the path is consistent with the history of the computer system based on the first number and the second number. A particular advantage is that consideration of the state transition history provides a more accurate prediction of future states, such as failure states.

In accordance with example implementations, the method further includes detecting a new state of the computer system, which is not part of the directed graph. Responsive to the detection, the data is updated to add the new state to the directed graph. Responsive to the detection, the data is further updated to add a transition identifier that is associated with a transition to the new state. A particular advantage is that consideration of the state transition history provides a more accurate prediction of future states, such as failure states.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
accessing data representing a directed graph of model states for a computer system, wherein the directed graph comprises a plurality of transitions among the model states, and the directed graph comprises, for each transition of the transitions, a transition identifier associated with the transition and a probability associated with the transition;
characterizing a history of the computer system to reach a current state of the computer system, wherein the current state corresponds to a given model state of the model states, the history corresponds to first transitions of the plurality of transitions, and characterizing the history comprises:
based on the data, identifying first transition identifiers of the transition identifiers associated with the first transitions; and
applying a first arithmetic operator to the first transition identifiers to provide a history identifier corresponding to the history; and
based on the history identifier, determining a likelihood that the computer system will transition from the current state to a given future state; and
based on the likelihood, initiating responsive action in anticipation of the computer system transitioning to the given future state.

2. The method of claim 1, wherein the computer system comprises a first computer system, the given future state corresponds to a failure of the first computer system, and the method further comprises, responsive to the alert, failing over the first computer system to a second computer system.

3. The method of claim 2, wherein failing over the first computer system to the second computer system comprises at least one of migrating a virtual machine of the first computer system to the second computer system, or transferring a workload assigned to the first computer system to the second computer system.

4. The method of claim 1, wherein the first transition identifiers comprise prime numbers, and the directed graph corresponds to a Markov chain.

5. The method of claim 4, wherein applying the first arithmetic operator comprises determining a product of the prime numbers.

6. The method of claim 1, wherein:
determining the likelihood that the computer system will transition to the next state comprises identifying a path of the directed graph based on the history identifier; and
the path comprises the given model state, the first transitions and a second model state of the model states corresponding to the given future state.

7. The method of claim 6, wherein:
the history identifier comprises a first number;
the path is associated with a second number; and
identifying the path comprises determining whether the path is consistent with the history of the computer system based on the first number and the second number.

8. The method of claim 1, wherein:
determining the likelihood that the computer system will transition to the given future state comprises identifying a path of the directed graph based on the history identifier and a probability associated with the path;
the path comprises the given model state, the first transition and a second model state of the model states corresponding to the next state;
the path comprises at least one transition of the plurality of transitions from the given model state to the second model state; and
the probability associated with the path corresponds to the probability or probabilities associated with the at least one transition.

9. The method of claim 1, wherein the given future state corresponds to a failure of the computer system.

10. The method of claim 1, further comprising:
detecting a new state of the computer system that does not correspond to a model state of the model states;
responsive to the detection, updating the data to add another model state to the directed graph correspond to the new state; and
responsive to the detection, further updating the data to add a transition identifier associated with a transition to the other model state.

11. A non-transitory storage medium storing machine-readable instructions that, when executed by a machine, cause the machine to:
access first data representing events associated with a computer system, wherein the events correspond to respective computer system states, and the computer system states comprises a current computer system state;
access second data representing a directed graph of model states for the computer system, wherein the directed graph comprises a plurality of transitions among the model states, and the directed graph comprises, for each transition of the transitions, a different first prime number associated with the transition and a probability associated with the transition;
associate computer system states to the first model states, wherein the associating includes associating a given first model state to the current computer system state;
determine a second number based on a transition history of the given first model state;
determine, based on the second number and the directed graph, whether the computer system is likely to transition from the current computer system state to a given future computer system state of the computer system states; and
based on the determination of whether the computer system is likely to transition from the current computer system state to the given future computer system state, initiate a remedial action for the computer system.

12. The storage medium of claim 11, wherein the instructions, when executed by the machine, further cause the machine to:
identify first transitions of the plurality of transitions corresponding to the transition history; and
multiply the first prime numbers associated with the first transitions together to determine the second number.

13. The storage medium of claim 11, wherein the instructions, when executed by the machine, further cause the machine to:
access third data representing candidate paths of the directed graph, wherein each candidate path of the candidate paths comprises a second model state corresponding to the given future computer system state, and each candidate path of the candidate paths has an associated third prime number; and
select a given candidate path of the candidate paths based on the third prime numbers and the second number, wherein the given candidate path comprises at least one transition of the plurality of transitions from the given model state to the second model state; and
determine a likelihood of the computer system transitioning to the given future computer system state based on the probability or probabilities associated with the at least one transition.

14. The storage medium of claim 11, wherein the given future computer state comprises a failure state, and the remedial action comprises at least one of migrating a virtual machine from the computer system to another computer system, or migrating a workload of the computer system to another computer system.

15. The storage medium of claim 11, wherein the directed graph comprises a Markov chain.

16. An apparatus comprising:
a plurality of computer systems comprising a first computer system; and
a management controller to:
access first data representing a directed graph of model events for the first computer system, wherein the directed graph comprises a plurality of transitions among the model events, and the directed graph comprises, for each transition of the transitions, a transition identifier associated with the transition and a probability associated with the transition;
access second data representing actual events of the first computer system, wherein the actual events comprise a given actual event;
characterize a history of the first computer system preceding the actual event, wherein the given actual event corresponds to a given model event of the model events, the history corresponds to first transitions of the plurality of transitions, and characterizing the history comprises:
based on the data, determining first transition identifiers of the transition identifiers associated with the first transitions; and
applying a first arithmetic operator to the first transition identifiers to provide a history identifier corresponding to the history; and
based on the history identifier, determine a likelihood that the first computer system will experience a future actual event corresponding to a second model event of the model events; and
based on the likelihood, initiate a remedial action for the first computer system.

17. The apparatus of claim 16, wherein
the first transition identifiers comprise first prime numbers; and
the management controller to further multiply the prime numbers together to determine a second prime number representing the history identifier.

18. The apparatus of claim 17, wherein the management controller to further:
identify a path of the directed graph based on the second prime number, wherein the path comprises the given model state, the first transitions and a second model state of the model state corresponding to the second state, and the path is associated with a third prime number, wherein identifying the path comprises:
determining whether the second prime number is a factor of the third prime number; and
selecting the path from a plurality of candidate paths responsive to a result of the determination of whether the second prime number is a factor of the third prime number.

19. The apparatus of claim 16, wherein the management controller comprises a chassis management controller, and the plurality of computer systems comprise computer systems of a rack-based computing system.

20. The apparatus of claim 16, wherein:
the directed graph corresponds to a Markov chain; and
the directed graph is associated with one of a memory subsystem of the first computer system, a processor subsystem of the first computer system, or an expansion card subsystem of the first computer system.
